(19) United States
(12) Patent Application Publication
(10) Pub. No.: US 2012/0093977 A1
(43) Pub. Date: Apr. 19, 2012

(54) FOOD PRODUCTS COMPRISING ZEOLITES

(76) Inventors: Dario Brunello, Mestre (VE) (IT); Luca Tombolan, Mestre (VE) (IT); Alessandro Farinato, Mestre (VE) (IT)

(21) Appl. No.: 13/375,584

(22) PCT Filed: May 12, 2010
(86) PCT No.: PCT/IB2010/001100

§ 371 Date: Dec. 30, 2011

(30) Foreign Application Priority Data
Jun. 5, 2009 (IT) MI2009A000987

(51) Int. Cl. A23L 1/30; A23L 2/78; A23L 1/39; A21D 13/08; A23L 1/36; A23L 1/16; A23L 3/3454; A21D 13/00

(52) U.S. Cl. 426/2; 426/531; 426/271; 426/615; 426/590; 426/549; 426/560; 426/632; 426/557; 426/589

(57) ABSTRACT

The present invention concerns food products comprising zeolite, in particular clinoptilolite and optionally in combination with other inorganic components able to reduce absorption of the ethanol ingested via the consumption of alcoholic drinks. A further subject-matter of the invention is a clinoptilolite having characteristic purity and granulometry.

### TECHNICAL BACKGROUND

Zeolites are minerals with a regular microporous crystalline structure characterised by an enormous number of empty volumes inside the crystals. The crystal lattice of zeolite consists substantially of silicon oxides and aluminium oxides.

A huge number of zeolites exists, natural and synthetic, many of which have properties useful in industry: they are used for example in the petrochemical industry, as catalysts, or are added to detergents to replace polyphosphates; they are also used in agriculture, in the building industry, and in water softening in cosmetics.

Clinoptilolite is a particular zeolite of natural origin formed from the conversion of vitreous volcanic materials into a crystalline structure in the waters of lakes or the sea. One of the prime characteristics of clinoptilolite is its cation exchange capacity; this property is due to its electronic structure and the negative charges present, which make it particularly active, for example, in the neutralisation of free radicals.

The use of clinoptilolite in the purification of water or as an additive in animal feeds, for example to eliminate lead from water or to absorb the moulds present in food for animals, is known.

It is also known that the limited consumption of wine, especially red wine, for example two glasses a day, produces beneficial health effects, reducing the LDL cholesterol, the so-called “bad” cholesterol, and increasing the HDL cholesterol, i.e. the cholesterol defined as “good”, and also inhibiting platelet aggregation. Wine is furthermore a source of antioxidants, such as polyphenols, contains anti-carcinogenic substances and helps to maintain the patency of arteries. It has been observed, in fact, that a moderate consumption of wine can help to reduce cardiovascular risk thanks to the beneficial properties of the nutrients contained in it.

Many beneficial properties have been recognised also in beer. In fact, like red wine, this drink contains antioxidant substances which are useful for reducing the risk of cardiovascular disease. A moderate consumption of beer, which also contains group B vitamins, also helps to control homocysteine, the increase of which favours a predisposition towards cardiovascular disease.

However, the consumption of drinks such as wine or beer which, as said, have a beneficial nutritional action on the organism (in addition to representing a pleasure for the consumer due to their taste, which is why they have become part of our daily diet) has the drawback of entailing the consequent intake also of alcohol, in particular ethanol which, as is known, has many harmful health effects. In fact, it has been demonstrated that the ingestion and consequent absorption of ethanol causes, among other things, cutaneous vasoconstriction, especially in the so-called redness area (shoulders, neck and face), depressive effects on the central nervous system, causes arrhythmia and depresses the contractility of the cardiac muscle, leading in the long term to cardiomyopathy; ethanol furthermore causes an increase in blood pressure, irritates the gastro-intestinal mucous membranes and can interfere negatively with the effect of drugs acting on the central nervous system.

In short, the beneficial effects deriving from the consumption of beer and wine, discussed above, tend to be annulled by simultaneous absorption of the ethanol contained in said drinks.

### DESCRIPTION OF THE INVENTION

It has now been found that it is possible to reduce absorption of the ethanol ingested via the alcoholic drinks which are a customary part of the diet, such as wine and beer, by the simultaneous administration of food products comprising zeolites, in particular comprising a clinoptilolite, the chemical-physical properties of which can be optimised for the purpose.

Thus, according to one of its aspects, the invention relates to a food product for human use comprising micronised zeolite characterised in that at least 90% of the granules of said micronised zeolite have a particle size greater than 0.1 μm.

According to the present invention, “zeolite” indicates any zeolite for alimentary use, preferably clinoptilolite, advantageously a micronised zeolite, preferably micronised clinoptilolite.

According to a preferred embodiment, in the food product of the invention said micronised zeolite is micronised clinoptilolite.

Micronised zeolite or clinoptilolite can be prepared according to the techniques known to a person skilled in the art.

According to a preferred embodiment, in said micronised zeolite or clinoptilolite at least 90% of the granules have a particle size between 0.1 μm and 100 μm.

According to another preferred embodiment, in said micronised zeolite or clinoptilolite at least 90% of the granules have a particle size equal to approximately 20 μm.

The particle sizes are important for the purposes of the invention for a number of reasons. On the one hand the size must be small enough to permit effective absorption of the alcohol, since it has been noted that the smaller the particle size, the greater the absorption by the zeolite or clinoptilolite. On the other hand, too small a particle size, for example below 0.1 μm, can lead to absorption of the zeolite or clinoptilolite via the mucous membranes of the gastroenteric system and, apart from the potential toxicity of the product absorbed, it is obvious that for the purposes of the invention the zeolite or clinoptilolite used must not be absorbed.

According to the present invention, the expression “food product” includes a food in the commonest meaning of the term, like a functional food product or a food supplement, or also the products defined as “medical devices” by the current legislation.

By way of example, by food product we mean any substance or product transformed, partially transformed or non-transformed, intended to be ingested, or which it is reasonably envisaged that can be ingested, by human beings. Drinks, chewing gum and any substance, including water, intentionally incorporated in the food product during the production, preparation or treatment thereof are included.

According to a preferred embodiment, the food product is in liquid form.

A food product is generally defined as “functional” if it is demonstrated that it can entail an effect which is beneficial and targeted on one or more functions of the organism, above and beyond the appropriate and expected nutritional effects.

A “food supplement” is a product aimed at promoting the intake of certain nutritional ingredients not present in the food of persons who do not follow a correct balanced diet.

A “medical device” is currently defined under Italian law (D.L. No. 46/1997), as “an apparatus, a plant, a substance or other product used alone or in combination including the software used for the correct operation thereof, and intended by the manufacturer to be used in humans for the purpose of diagnosis, prevention, control, treatment or alleviation of a disease; diagnosis, control, treatment, alleviation or compensation of an injury or a handicap; study, replacement or modification of the anatomy or of a physiological process; contraceptive means”.

According to another preferred embodiment of the invention, zeolite is micronised clinoptilolite in a particularly pure form.

As is known, clinoptilolite is a substance consisting of hydrated sodium, potassium and calcium aluminium silicon. The clinoptilolite commonly available on the market, however, also comprises other types of oxides, including calcium, magnesium, iron and sodium oxides, in addition to mineral impurities of other types. The presence of said impurities in the commercial substance therefore lowers the clinoptilolite content, in some cases resulting in commercial substances containing 80% clinoptilolite.

According to a preferred embodiment of the invention, micronised clinoptilolite has a content of clinoptilolite, understood as hydrated sodium, potassium and calcium aluminium silicon, higher than 88%, advantageously equal to or higher than 90%.

According to another of its embodiments, the food product of the invention also comprises, in addition to the zeolite and clinoptilolite as defined above, silicon dioxide (SiO₂) and/or aluminium oxide (Al₂O₃) and/or aluminium hydroxide (Al(OH)₃), preferably silicon dioxide (SiO₂) and aluminium oxide (Al₂O₃).

By way of example, the food product of the invention can comprise approximately 40-60% (w/w) of micronised clinoptilolite as defined above and 40-60% (w/w) of silicon dioxide (SiO₂) and/or aluminium oxide (Al₂O₃).

It has been unexpectedly noted, in fact, that by combining the zeolite and/or the clinoptilolite with silicon dioxide (SiO₂) and/or aluminium oxide (Al₂O₃) and/or aluminium hydroxide (Al(OH)₃), advantageously with silicon dioxide (SiO₂) and/or aluminium oxide (Al₂O₃) or also only with silicon dioxide (SiO₂), a synergic effect is obtained for the purposes of the invention.

In other words, the combination defined above prevents the absorption of large quantities of alcohol, in particular ethanol, by the organism.

The invention also concerns the use of micronised zeolite and/or clinoptilolite, optionally combined with silicon dioxide (SiO₂) and/or aluminium oxide (Al₂O₃) and/or aluminium hydroxide (Al(OH)₃), for the preparation of a food product intended to limit absorption of the ethanol ingested via alcoholic drinks in a human subject.

The food products according to the invention include drinks, baked products, sweet or savoury, such as bread, pizza, focaccia, crackers, biscuits, tarts, snacks, sweets and similar; snacks such as crisps, dried fruit and nuts, bars, tortillas and similar; fresh or dry pasta, whether made of durum wheat flour, soft wheat flour, spelt flour, rice flour etc., or ready meals, sauces etc.

Thus, the food product according to the invention, when consumed together with a moderate quantity of an alcoholic drink, in particular wine or beer, results in a significant reduction in the absorption of ethanol, thus allowing the organism to enjoy only the benefits of said drinks.

The food product of the invention can therefore be used in the daily diet, to limit the harmful effects of the ethanol contained in the alcoholic drinks habitually consumed during meals, such as wine and beer.

It is obvious that the food product of the invention can be consumed with alcoholic drinks other than wine and beer, such as aperitifs, liqueurs and other drinks containing ethanol, preferably with a moderate alcohol content.

The food product of the invention furthermore permits a modest consumption of drinks having a moderate alcohol content also by persons who, for various reasons, have to follow a diet which excludes alcohol. In fact, thanks to the simultaneous consumption of the food product of the invention, said persons can benefit from the salutary components of the drinks described above, such as wine and beer, without running health risks.

The food product of the invention can be prepared according to the normal techniques for preparation of the chosen food, mixing an appropriate quantity of micronised clinoptilolite, as defined above, with the mixture of ingredients necessary for the production of said food.

Thus, for example, for the preparation of a baked product, the micronised zeolite or clinoptilolite can be added to the mixture to be baked. Alternatively, the micronised zeolite or clinoptilolite can be added to the flours necessary for the preparation of said mixture and the food product can be made according to the known techniques.

Flour for human use comprising micronised zeolite or clinoptilolite as defined above constitutes a further subject-matter of the invention. Said flour includes for example durum wheat flour, soft wheat flour, maize flour, rice flour etc.

As said, according to one of the preferred embodiments of the invention, the food product is in liquid form. For said purpose, the zeolite, advantageously the micronised clinoptilolite as defined above, can be mixed with other components such as water, juices or extracts of fruit or vegetables, flavours, sugar or sweeteners, salt, essential oils, etc.

By way of example, the food product in liquid form can be in single-dose or multi-dose form, for example in single-dose packages of 25-100 ml, for example around 35 ml. Said food product in liquid form can for example contain between 5 and 30%, advantageously around 15%, of micronised clinoptilolite.

The effect of the micronised clinoptilolite on limitation of absorption of the ethanol ingested by a person via alcoholic drinks has been demonstrated by means of in vitro and in vivo assays. Details of said assays are reported in the experimental section of the present description.

It has thus been observed that the quantities of micronised clinoptilolite necessary to counter the negative effects due to the alcohol contained in alcoholic drinks, such as wine and beer, are in the order of 0.5-2 g, for example approximately 1 g of micronised clinoptilolite for 4-6 ml of ethanol.

Therefore by way of example, 2-3 g of micronised clinoptilolite are able to inhibit absorption of the ethanol contained in approximately 100 ml, the equivalent of a glass of wine.

In the same way, 3-6 g of micronised clinoptilolite are able to inhibit absorption of the ethanol contained in 330 ml of beer, the equivalent of a medium-sized bottle or a can.

Performing some simple calculations, within the grasp of an averagely skilled in the art, it is easy to determine the quantity of micronised clinoptilolite to be added to the food product according to the invention in order to annul the negative effects of a certain quantity of alcoholic drink customarily ingested.

Said dosages can naturally be varied as required by the person taking the zeolite or the clinoptilolite for the use according to the invention.

Thus, purely by way of example, bread or crackers can be prepared for eating with meals, or liquid mixtures, comprising micronised clinoptilolite as defined above in an amount from 2 to 10 g, for example 3-6 g, per ration in order to prevent the absorption of two glasses of wine, or a small bottle or can of beer, consumed with the meal.

The use of micronised clinoptilolite as defined above, and in particular as defined in the preferred and/or advantageous embodiments of the invention, optionally in the combinations defined above, for the preparation of food products constitutes a further subject-matter of the invention.

The use of micronised zeolite or clinoptilolite as defined above, and in particular as defined in the preferred and/or advantageous embodiments of the invention, optionally in the combinations defined above, to limit the absorption of ethanol ingested via alcoholic drinks, preferably moderately alcoholic drinks, constitutes a further subject-matter of the invention.

According to another of its aspects, the invention concerns a method for limiting absorption of the ethanol ingested via the consumption of alcoholic drinks in a human subject, which comprises ingesting, simultaneously with the consumption of said alcoholic drink, an effective quantity of a food product according to the invention.

### EXPERIMENTAL SECTION

### Example 1a

In vitro Assay on the Ethanol-Absorbing Properties of Micronised Clinoptilolite

Tests were performed on the absorption of ethanol from hydroalcoholic solutions by varying quantities of micronised clinoptilolite (hereinafter only clinoptilolite) at a temperature varying between 18 and 24° C.

The readings of the absorptions were carried out on the basis of the reduction in alcohol concentration of the hydroalcoholic solutions after introduction of the clinoptilolite.

The experiments were performed by constituting each time 500 ml of hydroalcoholic solution using 95% alcohol and measuring the actual concentration with a series of Gay-Lussac areometers with different scales. The solutions were contained in 500 ml glass cylinders in which, at the beginning, the appropriate areometer was floated and the concentration of alcohol in the water was then read. As is known, calibration of the areometers is based on the different densities of the solutions at a given temperature, the density of alcohol being 0.79 at 20° C.

Weighed quantities of clinoptilolite were then placed in the cylinder, and in the pulp the variation in alcohol concentration was measured with the aerometer at different times, i.e. after 1′, 4′, 10′, 20′, 40′ and 60′. The density variation of the mixture (also without absorption) is negligible: in fact, when up to 15 g of clinoptilolite are placed in 500 ml of pure H₂O, the variation in volume is not significant.

All the readings relative to absorption of the ethanol by the clinoptilolite were performed in the pulp, i.e. in the suspension of the powder in the hydroalcoholic solution. Also the measurements of the alcoholic absorption at various time intervals were performed after vigorous stirring of the mixture, so as to re-suspend the inorganic matter undergoing sedimentation.

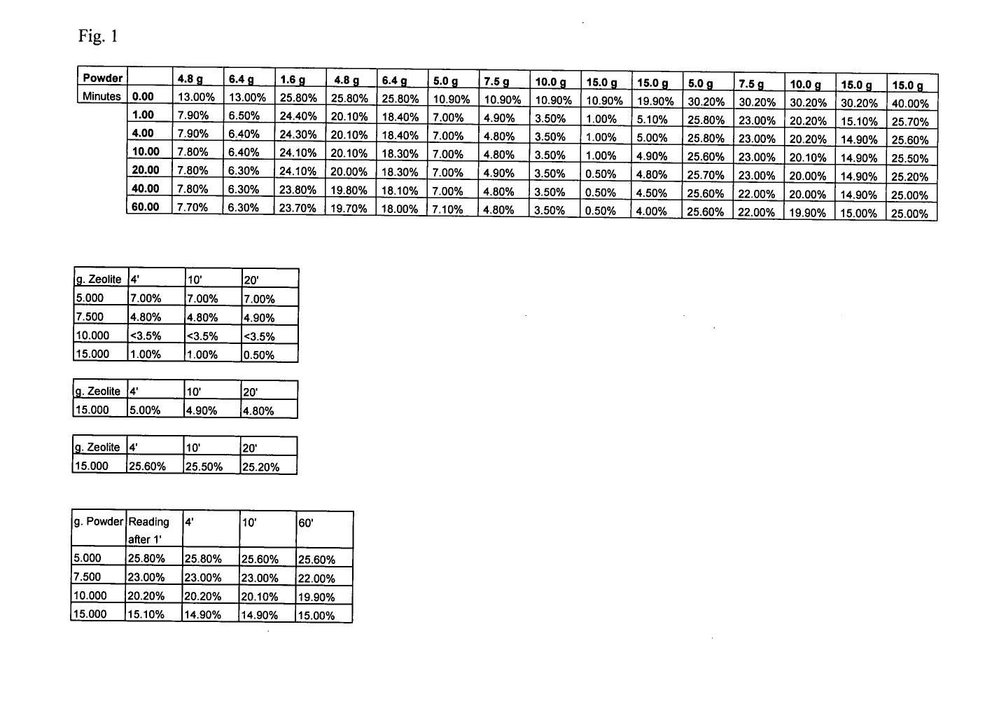

As can be seen from the tables of FIG. 1, the experimentation began with 30.20% solutions in alcohol; after treatment with 5 g of clinoptilolite powder, the concentration had reduced to 25.80% after approximately 1′, remaining more or less unchanged in the subsequent measurements. Since the initial solution was 500 ml, the relative quantity of ethanol of 160 ml had reduced by approximately 22 ml; i.e. 1 g of powder had sequestered 4.4 ml of alcohol.

Thus 500 ml of 30.20% hydroalcoholic solution in alcohol, after 1′ of treatment with 7.5 g of clinoptilolite, had reduced by 23%, i.e. by 36 ml:1 g of powder had absorbed 4.8 ml of alcohol.

500 ml of 30.20% hydroalcoholic solution in alcohol, after 1′ of treatment with 10 g of clinoptilolite had reduced its concentration to 20.20%, losing 50 ml of alcohol; i.e. 1 g of powder had absorbed 5 ml of ethanol.

500 ml of 30.20% hydroalcoholic solution in alcohol, after 1′ of treatment with 15 g of powder had reduced its concentration in alcohol to 15.10%, losing 75.5 ml, equivalent to approximately 5 ml/g.

Similarly, 500 ml of 25.80% hydroalcoholic solution in alcohol, treated with 6.4 g of powder, after 1′ measured a concentration of 18.4%, i.e. losing approximately 37 ml of ethanol, approximately 5.8 ml/g.

500 ml of 19.90% hydroalcoholic solution in alcohol, after 1′ of treatment with 15 g of clinoptilolite, measured a concentration of 5.10%, with a reduction of 74 ml of ethanol, i.e. each gram of powder had absorbed approximately 5 ml of alcohol.

500 ml of 13% hydroalcoholic solution, treated with 4.8 g of powder, after 60′ had reduced its concentration to 7.7%, i.e. 26.5 ml equivalent to an absorption of 5.5 ml of ethanol per gram of clinoptilolite.

Also from the numerous other examples, it appears evident that, in the experimental conditions adopted, the alcohol absorbed by the clinoptilolite used in the experiments is approximately 5 ml/g, corresponding to approximately 4 g of ethanol per gram of clinoptilolite.

### Example 1b

In Vitro Assay on The Ethanol-Absorbing Properties of Micronised Clinoptilolite Combined With Silicon Dioxide and/or Aluminium Oxide

The assay of example 1a was performed also on combinations of micronised clinoptilolite with silicon dioxide and/or aluminium oxide.

The results are shown in the Table of FIG. 2.

As can be seen, silicon dioxide and/or aluminium oxide alone have little or no effect on the absorption of ethanol. However, when combined with the micronised clinoptilolite, the absorption is surprisingly higher, and in the case of test tube no. 7 it is almost 30% higher compared to the absorption produced by the same quantity of clinoptilolite without silicon dioxide and aluminium oxide.

### Example 2

In Vivo Assay on The Ethanol-Absorbing Properties of Micronised Clinoptilolite in Healthy Volunteers

In this phase of the experimentation, two healthy subjects were informed that we would measure the ability of micronised clinoptilolite to absorb ethanol.

To perform the experiment, we carried out an anamnestic examination of the above two subjects to exclude metabolic pathologies and to ensure that they were not simultaneously being prescribed drugs.

The two subjects, aged respectively 43 and 47, were healthy persons, of athletic constitution, with few deposits of fat located in the region of the waist and hips, and no family history of alcohol or drug dependence.

The protocol used entailed the consumption of 250 ml of wine with 14% alcohol by volume simultaneously with three pieces of toast spread with peanut butter containing 5 grams of micronised clinoptilolite (test) or not containing micronised clinoptilolite (control), in a time of 20′.

Two test sessions were recorded: in the first, measurement of the BAC (blood alcohol concentration) with breathalyser was performed without the prior consumption of micronised clinoptilolite and in the second session with the consumption of 5 grams of micronised clinoptilolite.

The BAC measurements were taken at the following times:
1) Measurement at 20′ from the end of consumption of the alcoholic drink
2) “ ” at 40′
3) “ ” at 50′
4) “ ” at 65′
5) “ ” at 80′

Measurement of the BAC was performed in the same subject after consumption of the alcoholic drink (wine at 14°) without previously taking clinoptilolite and after taking 5 grams of clinoptilolite before consumption of the alcoholic drink, in the form indicated above.

Two separate test sessions were performed three days from each other.

The data recorded showed the following results:

First subject: after the consumption of 250 ml of wine with 14% alcohol by volume simultaneously with three pieces of toast spread with peanut butter without micronised clinoptilolite, in a time of 20′, measurement of the BAC gave the following results (control):
1) Measurement at 20′ from the end of consumption of the alcoholic drink 0.56
2) “ ” at 40′ 0.45
3) “ ” at 50′ 0.39
4) “ ” at 65′ 0.36
5) “ ” at 80′ 0.33

First subject: after the consumption of 250 ml of wine with 14% alcohol by volume simultaneously with three pieces of toast spread with peanut butter containing 5 grams of micronised clinoptilolite, in a time of 20′, measurement of the BAC gave the following results (test):
6) Measurement at 20′ from the end of consumption of the alcoholic drink 0.30
7) “ ” at 40′ 0.31
8) “ ” at 50′ 0.29
9) “ ” at 65′ 0.27
10) “ ” at 80′ 0.23

Second subject: after the consumption of 250 ml of wine with 14% alcohol by volume simultaneously with three pieces of toast spread with peanut butter without micronised clinoptilolite, in a time of 20′, measurement of the BAC gave the following results (control):
11) Measurement at 20′ from the end of consumption of the alcoholic drink 0.58
12) “ ” at 40′ 0.50
13) “ ” at 50′ 0.48
14) “ ” at 65′ 0.45
15) “ ” at 80′ 0.40

Second subject: after the consumption of 250 ml of wine with 14% alcohol by volume simultaneously with three pieces of toast spread with peanut butter containing 5 grams of micronised clinoptilolite, in a time of 20′, measurement of the BAC gave the following results (test):
16) Measurement at 20′ from the end of consumption of the alcoholic drink 0.31
17) “ ” at 40′ 0.36
18) “ ” at 50′ 0.36
19) “ ” at 65′ 0.32
20) “ ” at 80′ 0.29.

The test provided significant data correlated with the ability of the micronised clinoptilolite contained in a food to absorb the ethanol.

### Example 3

Food Product in Liquid Form

The following components are mixed cold, after filtering optionally or desired: fruit juices, vegetable juices, dextrose, salt, essential oils and micronised clinoptilolite in an amount of 15% in weight with respect to the total weight of the composition.

If desired or necessary, the liquid mixture is pasteurised before it is packed, for example by heating the food product for a few minutes at 50-90° C.

The food product is then packed in single or multi-dose containers.

### Example 4

Food Product in Liquid Form

The following components are mixed cold, after filtering optionally or desired: fruit juices, vegetable juices, dextrose, salt, essential oils, micronised clinoptilolite in an amount of 15% in weight with respect to the total weight of the composition, silicon dioxide (SiO₂) in an amount of approximately 25% in weight with respect to the total weight of the composition and aluminium oxide (Al₂O₃) in an amount of approximately 25% in weight with respect to the total weight of the composition.

If desired or necessary, the liquid mixture is pasteurised before it is packed, for example by heating the food product for a few minutes at 50-90° C.

The food product is then packed in single or multi-dose containers.

1. Food product for human use comprising micronised zeolite characterised in that at least 90% of the granules of said micronised zeolite have a particle size greater than 0.1 μm.

2. The food product as claimed in claim 1, characterised in that said micronised zeolite is micronised clinoptilolite.

3. The food product as claimed in claim 1, characterized in that in said micronised zeolite or clinoptilolite at least 90% of the granules have a particle size of between 0.1 μm and 100 μm.

4. The food product as claimed in claim 1, characterised in that in said micronised zeolite or clinoptilolite at least 90% of the granules have a particle size approximately equal to 20 μm.

5. Food product as claimed in claim 2, characterised in that said micronised clinoptilolite has a content of clinoptilolite, intended as hydrated sodium, potassium and calcium aluminium silicate, higher than 88%.

6. Food product comprising zeolite or clinoptilolite together with silicon dioxide (SiO₂) and/or aluminium oxide (Al₂O₃) and/or aluminium hydroxide (Al(OH)₃).

7. Food product as claimed in claim 6, characterised in that it comprises zeolite or clinoptilolite together with silicon dioxide (SiO₂) and/or aluminium oxide (Al₂O₃).

8. Food product as claimed in claim 6, wherein said zeolite or clinoptilolite has at least 90% of the granules of micronised zeolite with a particle size greater than 0.01 μm.

9. Combination which comprises 40-60% (w/w) of micronised clinoptilolite and 40-60% (w/w) of silicon dioxide (SiO₂) and/or aluminium oxide (Al₂O₃).

10. Use of micronised zeolite and/or clinoptilolite as defined in claim 1, for the preparation of a food product designed to limit absorption of the ethanol ingested via the consumption of alcoholic drinks in a human subject.

11. Use of zeolite and/or clinoptilolite in combination with silicon dioxide (SiO₂) and/or aluminium oxide (Al₂O₃) and/or aluminium hydroxide (Al(OH)₃) for the preparation of a food product designed to limit absorption of the ethanol ingested via the consumption of alcoholic drinks in a human subject.

12. Flour for human use comprising micronised zeolite or clinoptilolite.

13. Method for limiting the absorption of the ethanol ingested via the consumption of alcoholic drinks in a human, which comprises administering, simultaneously with the consumption of said alcoholic drink, an effective amount of a food product according to claim 1.

14. The food product according to claim 1, which is selected from drinks, baked products, sweet or savoury, such as bread, pizza, focaccia, crackers, biscuits, tarts, snacks, sweets, crisps, nuts, sweet or salted bars, tortilla, fresh or dry pasta and ready meals and sauces.

15. The food product according to claim 14, characterised in that it is in liquid form.

16. The food product according to claim 14, characterised in that it is a medical device.
